(19) United States
(12) Patent Application Publication
(10) Pub. No.: US 2015/0094999 A1
(43) Pub. Date: Apr. 2, 2015

(54) INTERFACE POINT METHOD MODELING OF THE STEAM-ASSISTED GRAVITY DRAINAGE PRODUCTION OF OIL

(71) Applicants: BP Corporation North America Inc., Houston, TX (US); Los Alamos National Laboratory, Los Alamos, NM (US)

(72) Inventors: William Brian VanderHeyden, Katy, TX (US); Duan Z. Zhang, Los Alamos, NM (US)

(21) Appl. No.: 14/502,418

(22) Filed: Sep. 30, 2014

Related U.S. Application Data
(60) Provisional application No. 61/884,284, filed on Sep. 30, 2013.

(51) Int. Cl. E21B 43/00; E21B 43/24; E21B 43/20; G06F 17/50

(52) U.S. Cl. CPC E21B 43/00; G06F 17/5018; E21B 43/2406; E21B 43/20
USPC 703/2

(57) ABSTRACT

A computer system and method of simulating the behavior of an oil and gas reservoir including movement of the steam-bitumen interface during oil production using the Steam Assisted Gravity Drainage (SAGD) technique. A system of equations including state equations involving momentum and heat transport for each phase, mass conservation equations, and heat balance equations, in combination with a continuity constraint, is defined and discretized for the modeled volume. A material point model technique for numerically solving the system of discretized equations is applied, where interface marker particles that move through the Eulerian grid represent the location of points along the steam-bitumen interface.

### CROSS-REFERENCE TO RELATED APPLICATIONS

This application claims priority, under 35 U.S.C. §119(e), of Provisional Application No. 61/884,284, filed Sep. 30, 2013, incorporated herein by this reference.

### STATEMENT REGARDING FEDERALLY SPONSORED RESEARCH OR DEVELOPMENT

The United States government has rights in this invention pursuant to Contract No. DE-AC52-06NA25396 between the United States Department of Energy and Los Alamos National Security, LLC for the operation of Los Alamos National Laboratory.

### BACKGROUND OF THE INVENTION

This invention is in the field of oil and gas (“hydrocarbon”) production. Embodiments of this invention are more specifically directed to systems and methods for modeling and simulating the behavior of hydrocarbon reservoirs.

In the current economic climate, the optimization of oil and gas production from identified reservoirs has become especially important. In this regard, considering that much of the readily available oil and gas reservoirs have been exploited or are currently in production, production of oil and gas in less producible forms, or from formations that are more reluctant to release their hydrocarbons, have become of increased interest. For example, large reservoirs of natural gas yet remain in so-called “tight” formations, in which the flow of gas into a production well is greatly restricted by the nature of the gas-bearing rock. These low permeability formations include tight sands, gas shales and gas coals, requiring such actions as hydraulic fracturing (“fracing”) to raise production levels. In the oil context, production of heavy oil from unconsolidated sands (“UCS”) has become economically attractive, even from cold climates such as northern North America. Especially in difficult formations such as these, the high economic stakes require operators to devote substantial resources toward effective management of oil and gas reservoirs and individual wells within production fields.

Recent advances in computational capability, in combination with the high economic stakes involved in reservoir and well management, have motivated reservoir engineers to develop models of reservoir behavior, for example based on seismic and other geological surveys of the production field, along with conclusions that can be drawn from well logs, pressure transient analysis, and the like. These models are applied to conventional reservoir “simulator” computer programs, by way of which the reservoir engineer can analyze the behavior of the reservoir over its production history, and by way of which the engineer can simulate the behavior of the reservoir in response to potential reservoir management actions (i.e., “what-if” analysis). An example of such a reservoir management action is the injection of gas or water into the reservoir to provide additional “drive” as reservoir pressure drops over cumulative production. Modern reservoir simulation systems and software packages assist the operator in deciding whether to initiate or cease such “waterflood” operations, how many wells are to serve as injection wells, the locations of those injectors in the field, and the like.

Some reservoir simulators approximate fluid flow in the reservoir on a grid of geometric elements, and numerically simulate fluid flow behavior using finite-difference or finite-element techniques to solve for pressure and flow conditions within and between elements in the grid. In such simulation, the state of the reservoir model is stepped in time from some defined initial conditions, allowing the simulation package to evaluate inter-element flows, pressures at each grid element, and the like, at each point within a sequence of time steps. The results of this simulation can, if reasonably accurate, provide the reservoir engineer with insight into the expected behavior of the reservoir over time.

Because the geographical scale of typical reservoir models is relatively large, extending over hundreds of yards or several miles, corresponding finite-difference production field models of even modest complexity can become quite large, in the number of grid cells or mesh nodes. The computational complexity and cost of simulating the behavior of models including large numbers of cells or nodes can thus become prohibitive, even with modern high performance computer systems. As such, it is useful to reduce the number of grid cells in the model, by increasing the volume of each grid cell. For example, a typical grid cell in a reasonably manageable finite-difference model of a large production field may be on the order of hundreds of feet on a side. And because the time frame over which the simulation is carried out is often relatively long (e.g., from weeks to years), the time steps between solution points can be relatively long (e.g., once daily to monthly) to keep the computational burden somewhat reasonable.

However, it has been observed, in connection with this invention, that some physical phenomena in some of these newly-exploited formations cannot be adequately modeled at a large geographical scale and a large time scale. For example, the production of heavy oil from UCS using the technique of Cold Heavy Oil Production with Sand (“CHOPS”) involves mechanisms that are not accurately modeled at large geographical and time scales.

Our prior copending application Ser. No. 13/649,655, filed Oct. 11, 2012 and published as U.S. Patent Application Publication No. US 2013/0096890, incorporated herein by this reference, describes a system and method of applying the “material point method” (“MPM”) in simulating the behavior of an oil and gas reservoir according to the CHOPS production technique, including the simulating of changes in the margins of frangible solids. Prior to that work, MPM modeling had been used in the simulation of the effects of weapons and ordnance, particularly in simulations of projectile-target interaction, including the interaction of an explosive projectile impacting a metal body and explosions near modeled buildings. MPM modeling uses both a Eulerian mesh and Lagrangian points to represent a material. The Lagrangian integration points move through the Eulerian mesh during the simulation time period. In a general sense, these particles move independently relative to one another (and are not connected to one another, as are mesh nodes in the mesh), but are influenced by their near neighbors at each simulation time point, according to particular shape functions. In each simulation time step, equations of motion are solved at grid cells of the Eulerian mesh, and for the Lagrangian particles moving through that mesh.

As described in the above-incorporated U.S. Patent Application Publication No. US 2013/0096890, a system of equations including state equations such as momentum and mass conservation, and one or more constraints such as volume fraction continuity, are defined and discretized for at least two phases in a modeled volume, one of which corresponds to frangible material. The material point model technique numerically solves the system of discretized equations to derive fluid flow at each of a plurality of mesh nodes in the modeled volume, and to derive the velocity of at each of a plurality of particles representing the frangible material in the modeled volume. A time-splitting technique improves the computational efficiency of the simulation while maintaining accuracy on the deformation scale. The method is described applied to derive accurate upscaled model equations for larger volume scale simulations, attaining high resolution simulation at locations of interest, without unduly consuming computational resources.

Another approach now being used to produce heavy oil, such as from oil sands, is referred to in the art as “Steam Assisted Gravity Drainage”, or “SAGD”. As known in the art, SAGD involves the use of pairs of wells, typically having horizontal segments extending within the oil sand formation, with one wellbore (the injection well) disposed above (i.e., closer to the surface) the other (the production well). The injection well injects steam into the surrounding oil sand, which liquefies bitumen retained by the oil sand. Bitumen, either in molten form or in an emulsion in water, flows downward in the formation to the surface via the production well. Water and other impurities in the flow are typically separated from the oil phase at a surface processing facility.

As in the case of other oil and gas production mechanisms, it is useful to simulate SAGD production, such as to evaluate the effects of well and production field activity on production from a reservoir over time. Ezeuko et al., “Investigation of Emulsion Flow in SAGD and ES-SAGD”, Heavy Oil Conference Canada, SPE 157830 (SPE, June 2012) describes a numerical approach for incorporating emulsion modeling into simulations executed using commercial reservoir simulators.

### BRIEF SUMMARY OF THE INVENTION

Embodiments of this invention provide a method and system for modeling and simulating the behavior of Steam Assisted Gravity Drainage (“SAGD”) in order to optimize production from a hydrocarbon reservoir.

Embodiments of this invention provide such a modeling and simulation method and system that can be executed via workstation-class and similar computer systems.

Embodiments of this invention provide such a modeling and simulation method and system that can accurately model and simulate small-scale physics at the steam-oil interface in SAGD production in the context of a large-scale production field.

Other objects and advantages of embodiments of this invention will be apparent to those of ordinary skill in the art having reference to the following specification together with its drawings.

A computerized method, system, and non-transitory medium storing computer program instructions, for modeling physical, thermal, and optionally chemical mechanisms occurring within small volumes at the steam-bitumen interface in SAGD production of oil from a sub-surface formation is provided. In particular, this method and system models the emulsifying of oil entrapped in the formation upon exposure to injected steam. The volume of interest is modeled by the combination of an Eulerian mesh representative of the sub-surface structure through which the fluid flows, with Lagrangian particles move with the steam-bitumen interface through the mesh during the simulation time period as the steam chamber grows over injection time. A system of state equations for momentum, enthalpy, and mass and energy conservation of each phase involved, in combination with a volume fraction continuity constraint, is solved at each simulation time step, from which the movement of the interface over time and also the fluid flow in the formation can be derived.

### BRIEF DESCRIPTION OF THE SEVERAL VIEWS OF THE DRAWING

FIGS. 1a and 1b are perspective and cross-sectional schematic views, respectively, of a portion of the sub-surface including a producing oil well pair according to the Steam Assisted Gravity Drainage (SAGD) method, and in connection with which embodiments of this invention are implemented.

FIGS. 2a and 2b are graphical representations of Eulerian-Lagrangian, and Material Point Method (MPM), representations of the deformation of a body, respectively.

FIGS. 2c and 2d are cross-sectional schematic views of a portion of the sub-surface shown in FIGS. 1a and 1b, schematically illustrating the application of the IPM representation to the SAGD interface.

FIG. 3 is an electrical diagram, in schematic form, of a networked computer system programmed to execute various processes in the modeling and simulation of a gas reservoir, according to embodiments of the invention.

FIG. 4 is a flow diagram illustrating the operation of the system of FIG. 3 in the modeling and simulation of multi-phase interactions in the sub-surface of the earth in connection with the production of oil and gas products, according to embodiments of the invention.

FIG. 5 is a flow diagram illustrating the operation of the system of FIG. 3 in solving systems of state equations in the modeling and simulation process of FIG. 4, according to embodiments of the invention.

### DETAILED DESCRIPTION OF THE INVENTION

This invention will be described in connection with its embodiments, namely as implemented into a computerized system and method of operating the same for modeling and simulating the fluid and structural behavior in the sub-surface of a production field from which oil is produced by the Steam Assisted Gravity Drainage (SAGD) process, as it is contemplated that this invention will be especially beneficial in such an application. It is also contemplated, however, that embodiments of this invention can be beneficially implemented in other situations and applications in the development and production of oil, gas, and other hydrocarbons, such as hydraulic fracturing and oil sand perforation. Accordingly, it is to be understood that the following description is provided by way of example only, and is not intended to limit the true scope of this invention as claimed.

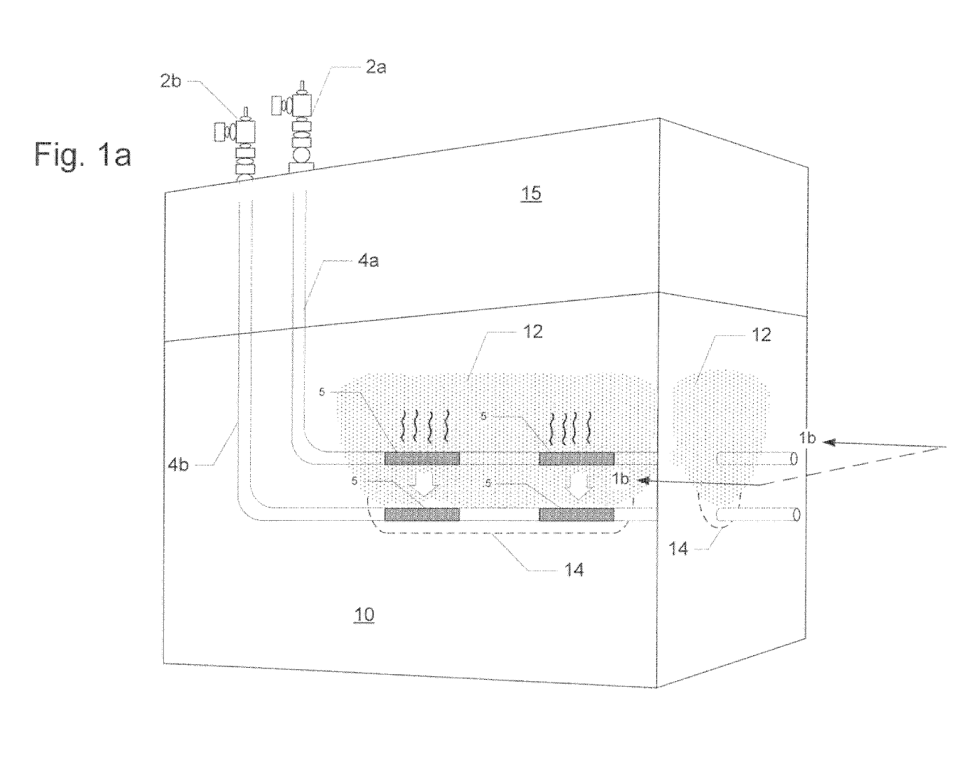

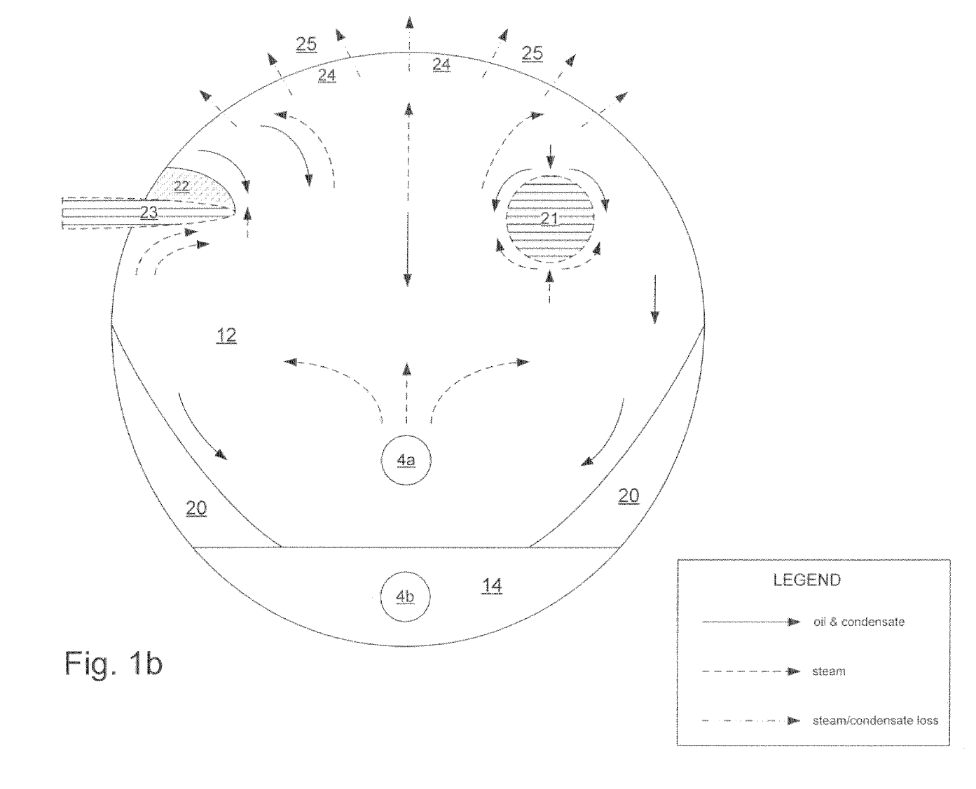

FIGS. 1a and 1b schematically illustrate the production of oil by way of the SAGD process. In the example of a SAGD production field illustrated in FIG. 1a, paired wellbores 4a, 4b extend into the earth from corresponding surface wellheads 2a, 2b, to a depth reaching into oil sand formation 10, which in this case is an oil-bearing stratum in the earth. Oil sand 10 underlies overburden formation 15, which has the effect of “sealing” the hydrocarbons into oil sand 10, as is typical in many oil sand regions of the earth. Each of wellbores 4a, 4b has horizontal segments running within oil sand 10, those segments running essentially parallel to one another. In this example, this horizontal segment of wellbore 4a runs directly above (i.e., closer to the surface) wellbore 4b. Perforations 5 are located along these horizontal segments of wellbores 4a, 4b within oil sand 10.

According to the SAGD example illustrated in FIG. 1a, wellbore 4a serves as a steam injection well and wellbore 4b serves as a production well. Steam is injected at wellhead 2a into wellbore 4a. This steam escapes from perforations 5 along the horizontal segment of wellbore 4a, as suggested in FIG. 1a, forming one or more “steam chambers” 12 within oil sand 10. Steam chamber 12 refers to a portion of oil sand 10 within which the injected steam largely remains in its vapor phase. Oil entrained in oil sand 10 is melted or emulsified by this steam and flows downward through the formation (depending on its permeability), pooling within liquid zone 14 beneath steam chamber 12 as an emulsion of oil and water. Reservoir pressure produces oil, water, and impurities up through wellbore 4b to wellhead 2b at the surface.

FIG. 1b illustrates an example of the SAGD mechanisms occurring in a cross-section of the steam chamber 12. As shown in this FIG. 1b, injection wellbore 4a is disposed directly above production wellbore 4b, separated by a vertical distance selected. Steam emanating from injection wellbore 4a forms steam chamber 12 within oil sand 10 (FIG. 1a). Various mechanisms can be occurring within steam chamber 12, as shown by way of example in FIG. 1b.

The primary SAGD mechanism is the heating and emulsifying of oil retained within oil sand 10. As described above, wellbores 4a, 4b are located within oil sand 10, which typically consists of unconsolidated sand within which oil is retained. Steam injected at wellbore 4a steam will emulsify the oil, with the resulting emulsion of oil and water (and typically other impurities) able to flow downward through the unconsolidated sand under the force of gravity. Steam chamber 12 is formed as those locations of oil sand 10 immediately adjacent to wellbore 4a, from which oil has been emulsified and produced; as such, steam chamber 12 has a relatively low oil saturation, thus permitting the oil-condensate emulsion to flow downward.

The emulsifying mechanism occurs at the edge of steam chamber 12, for example at thermal zone 25. Thermal zone 25 refers to an “unswept” zone of oil sand 10 that is heated and otherwise impacted by the injected steam, but which still retains a relatively high oil saturation level of native bitumen. As the oil in thermal zone 25 is heated and emulsified, that oil will proceed (under the force of gravity) to ceiling drainage zones 24 within steam chamber 12, from which the oil-condensate emulsion will flow downward through the relatively low oil saturation region of steam chamber 12 to liquid zone 14. The emulsion will also tend to collect and flow through slope drainage zones 20 along the lower sides of steam chamber 12. The oil-condensate emulsion pools within liquid zone 14, directly beneath injection wellbore 4a, within which production wellbore 4b is disposed. The pressure interior to wellbore 4b is sufficiently low, relative to the reservoir pressure of oil sand 10, that the oil-condensate emulsion travels through wellbore 4b to the surface. As oil is produced, the oil saturation immediately outside of steam chamber 12 will fall, and steam chamber 12 will tend to grow.

Often, complicating structures or features may be present within oil sand 10. One example of such a structure is shown in FIG. 1b as low permeability zone 21 within steam chamber 12. The low permeability of this region will tend to trap whatever oil is entrained within that rock, such that little oil may be emulsified and produced from that region. As such, steam and emulsion will tend to flow around low permeability zone 21, as suggested by FIG. 1b. FIG. 1b illustrates another low permeability structure 23, projecting into steam chamber 12 from the side. This location of structure 23, along with its relatively flat top surface, impedes the downward gravity-fed flow of oil-condensate emulsion from ceiling drainage zone 24. Trapped oil zone 22 is formed above low permeability structure 23 in this example, as shown.

Several physical and chemical processes are involved in the emulsification and flow of oil in the SAGD context. These mechanisms include the phase change of steam to water, heat conduction and convection in the porous oil sand media, the reduction in oil viscosity and surface tension as temperature increases, the mechanism by way of which oil drops are detached from the sand matrix, the emulsion formation mechanism by way of which oil droplets are entrained in water condensed form the injected steam, and the possibility and extent of phase inversion in the oil-condensate mixture, among others. These complicated mechanisms ought to be considered if one is to accurately simulate or model the production of oil using the SAGD method. But not only are the number and nature of these mechanisms and processes somewhat complex, important mechanisms are present both at the pore scale and at the macroscopic scale (i.e., at the scale of the SAGD chamber).

It has been observed, according to this invention, that these complicated processes and the wide range of scale involved in the production of oil using the SAGD technique limit the ability of conventional modeling and simulation tools are unable to accurately and rigorously simulate the production of oil and the behavior of the reservoir in the SAGD context. For example, while the Ezeuko et al. article cited above presents an approach to the simulation of SAGD production, it has been observed, in connection with this invention, that this simulation approach misses some of the finer level of detail of steam “fingering” for a given level of discretization. Conversely, the level of discretization necessary, according to the Ezeuko et al. simulation approach, to detect a fine level of steam fingering necessarily involves a prohibitive computational cost. As such, it has been observed to be practically impossible to consider all of the important physical and chemical processes involved in SAGD production over all scales, in a single numerical simulation package using conventional techniques.

According to this invention, it has been discovered that the material point methods (MPM) of simulation of multiphase flows, which have been used in analysis of ballistics and explosion processes and events, and in the modeling and simulation of oil production according to the Cold Heavy Oil Production with Sand (CHOPS) technique, can be effective in the simulation of the mechanisms involved in the context of oil and gas production using the SAGD technique. More specifically, according to this invention, it has been discovered that MPM-based simulation can be applied to represent the physical and chemical interactions at and near the interface between the hot injected steam and the bitumen, even though that interface is so physically thin as to be far below the typical grid resolution applied in reservoir modeling (at reasonable computational cost levels). The embodiments of the invention described below in this specification are based on this discovery that this conventional MPM tool can be used in the SAGD context, to which MPM has not heretofore been applied.

Theory of Operation

As described in Zhang et al., “Material point method applied to multiphase flows”, J. Computational Physics 227 (Elsevier, 2008), pp. 3159-73, incorporated herein by reference, the material point model (MPM) numerical technique is a known method for simulations involving deformable structures. According to the MPM approach, the material under analysis is represented both by a Eulerian mesh and by Lagrangian integration points, with the Eulerian mesh remaining fixed through the simulation time, while the Lagrangian points move through the mesh as the material deforms. The Lagrangian points are not structurally connected to one another, each point moving independently through the coordinate system, but are influenced by neighboring points according to a shape function. As described in the Zhang et al. article, MPM simulation has been observed to be useful in cases of large deformations in the material under consideration, without the “tangling” of the Lagrangian mesh that occurs in conventional approaches to simulating deformation of material bodies.

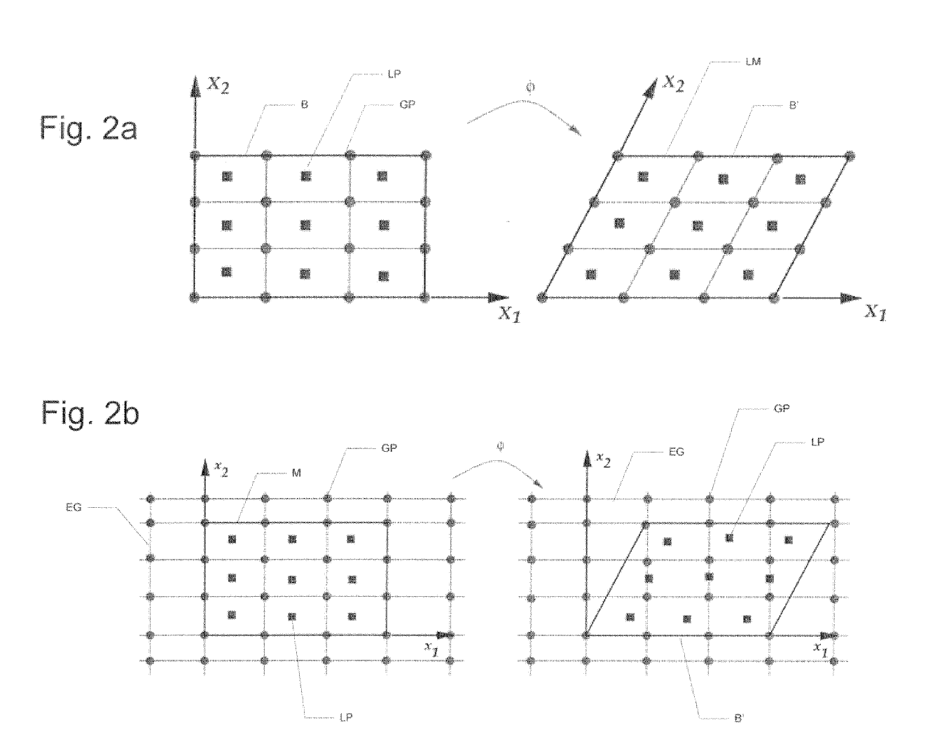

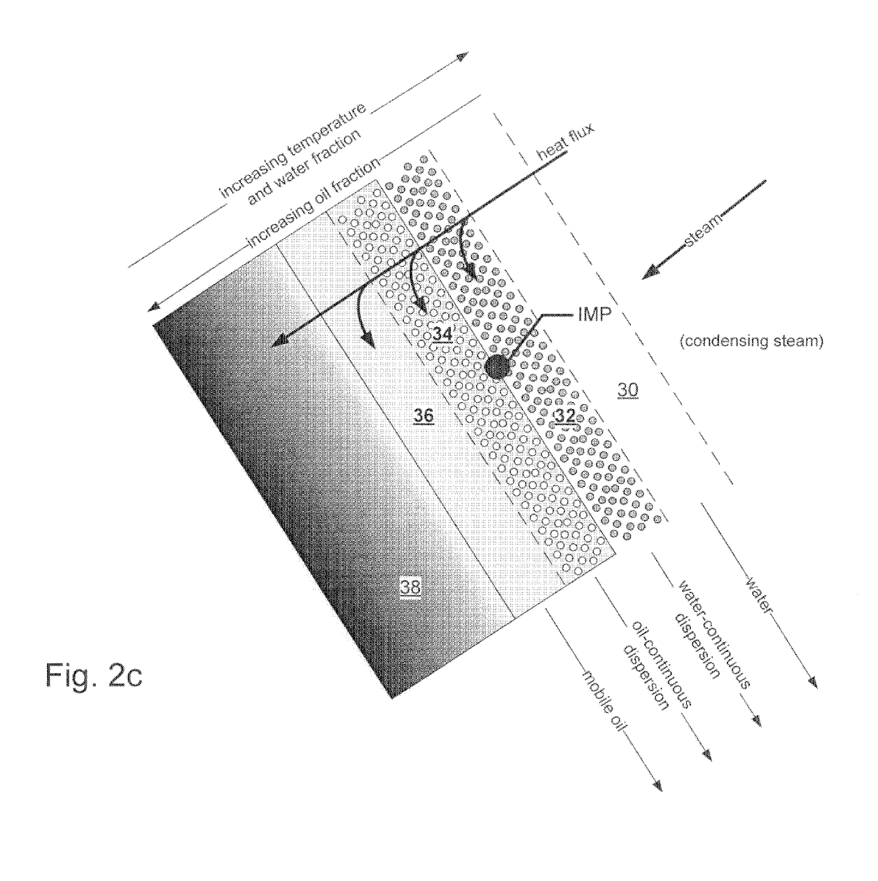

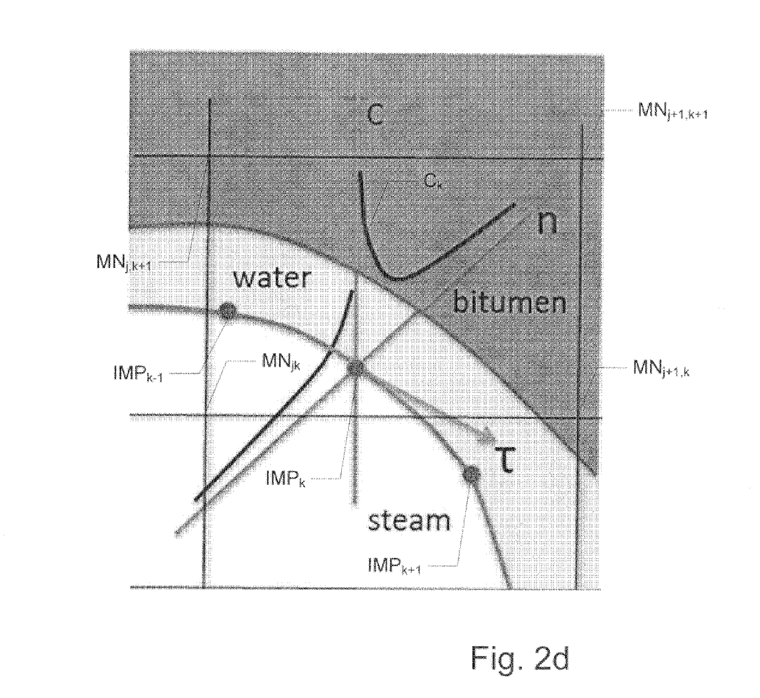

FIGS. 2a and 2b illustrate the distinction between conventional Lagrangian approaches and the MPM technique in simulating the deforming material. FIG. 2a illustrates two-dimensional body B prior to, and after, a deformation φ in response to a force exerted in the +X₁ direction (into deformed body B′). As shown in the left-hand side of FIG. 2a, body B is represented as coincident with several Lagrangian mesh nodes GP, the space among which can be considered as grid cells in the two-dimensional space. Lagrangian integration points LP are also shown in FIG. 2a, for the sake of comparison. Deformation φ in the +X₁ direction (non-uniform deformation with displacement increasing for increasing position in the +X₂ direction) results in deformed body B′. As shown in FIG. 2a, this deformation is represented by a corresponding deformation in Lagrangian mesh LM itself; the mesh nodes GP move along with the displacement of the deformation φ. If the simulation interval were extended further, the grid cells within Lagrangian mesh LM would shrink to infinitesimal size in at least one dimension; more complex deformations can cause the Lagrangian mesh to actually tangle.

In contrast, FIG. 2b illustrates the effect of the same deformation φ of body B according to a representation as useful in MPM simulation. The left-hand image in FIG. 2b corresponds essentially to that of FIG. 2a; Eulerian grid EG is illustrated as extending beyond the boundary of body B. In this case, Eulerian grid EG and its mesh nodes GP define a space within which body B resides. Lagrangian points LP are in the same locations as before. After deformation φ, however, Eulerian grid EG and its mesh nodes GP remain at the same location as before, regardless of the motion of body B into deformed body B′. The change in body B′ is represented instead by the movement of Lagrangian points LP within the fixed Eulerian grid EG.

The MPM numerical technique essentially combines the Eulerian mesh and Lagrangian points to represent the deformation of a material. More specifically, at each time step, MPM solves for motion of the Lagrangian points (i.e., particles) and also the state quantities at the Eulerian mesh nodes. During deformation, the Eulerian mesh or grid stays fixed in position, while the Lagrangian points move while carrying quantity values such as mass, microscopic density, velocity, and the like. The quantity values of each Lagrangian point (or changes in those quantities) are interpolated back and forth between the Eulerian grid and the Lagrangian points based on specified shape functions. Further detail in the theory of operation of one implementation of the MPM technique is described in Zhang et al., “CartaBlanca Theory Manual: Multiphase Flow Equations and Numerical Methods”, Los Alamos National Laboratory Report No. LAUR-07-3621 (2007), available at http://www.lanl.gov/projects/CartaBlanca/, and incorporated herein by this reference. As such, the MPM technique has been applied to problems involving interactions of different materials or fluids. For example, our prior work described in the above-incorporated U.S. Patent Application Publication No. US 2013/0096890 describes the application of the MPM technique in simulating the formation of “wormholes” in the production of oil by way of the CHOPS technology.

According to this invention, MPM numerical simulation is applied to the simulation of the movement of the interface between hot injected steam and bitumen in the context of Steam Assisted Gravity Drainage (SAGD) production of oil. More specifically, the Eulerian mesh nodes define a structure through which fluids, such as steam, oil, condensate, and the like flow over the simulation time, while generalized Lagrangian points represent the location of the interface between steam and bitumen, such as at the interface between steam chamber 12 and thermal zone 25 in the cross-section of FIG. 1b, as that interface moves over time during SAGD production. As such, the application of the MPM approach to evaluation of the SAGD technique, according to embodiments of this invention, will be referred to in this description as the “interface particle method”, or “IPM”, as the particles will be tracking the movement of an interface rather than the movement of specific elements of material.

FIG. 2c schematically illustrates a detailed representation of the steam-bitumen interface at the edge of steam chamber 12 of FIGS. 1a and 1b, at which the mechanisms involved in the production of oil by the SAGD technique are represented by the numerical technique implemented according to embodiments of the invention. In this representation, the interface is considered as five layers bounded by and including steam layer 30 and immobile oil layer 38, separated by interface layers 32, 34, 36.

Steam layer 30 refers to a region of oil sand 10 at the interior edge of steam chamber 12 (FIG. 1b), from which oil has already been produced earlier in SAGD production time, and therefore in which the oil saturation level is relatively low. Steam layer 30 is nearest to the source of injected steam (i.e., injection wellbore 4a), and as such exhibits the highest temperature and water fraction among the five interface layers 30 through 38, and the lowest oil fraction. To the extent liquid is produced from steam layer 30, this liquid consists essentially of water from condensing steam.

Interface layer 32 is the layer of the steam-bitumen interface immediately adjacent to steam layer 30, in the direction away from injection wellbore 4a. Interface layer 32 is characterized by its produced liquid consisting essentially of a water-continuous dispersion, namely oil droplets suspended in water. Interface layer 32 thus exhibits a higher oil fraction and lower water fraction, and is at a lower temperature, as compared with steam layer 30.

Interface layer 34 is the next most-distant layer from wellbore 4a, and is immediately adjacent to interface layer 32. Less of the injected steam reaches interface layer 34 than interface layer 32, and the steam that does reach layer 34 is at a lower temperature. Accordingly, the liquid produced from interface layer 34 consists essentially of an oil-continuous dispersion (i.e., water droplets suspended in oil). As such, interface layer 34 exhibits a higher oil fraction and lower water fraction than adjacent interface layer 32, and is at a lower temperature than interface layer 32.

Mobile oil layer 36 is the next most-distant layer from wellbore 4a, and is immediately adjacent to interface layer 34; as such, mobile oil layer 36 is at a lower temperature than its neighboring interface layer 34. Mobile oil layer 36 is a region of oil sand 10 in which the entrained oil has been heated to such an extent that it can flow from oil sand 10 under the force of gravity, but is sufficiently distant from the injected steam that little condensed water from the injected steam is produced with this oil. Accordingly, the liquid produced from mobile oil layer 36 consists essentially of oil, with little if any water entrained in that liquid. Mobile oil layer 36 thus exhibits a higher oil fraction and lower water fraction than interface layer 34.

Immobile oil region 38 can be considered as the layer of the steam-bitumen interface at oil sand 10 most distant from the injected steam source (i.e., injection wellbore 4a), within which oil is entrained within unconsolidated sand in a form that is essentially immobile, but at a relatively high oil saturation level as compared with the other interface layers 30 through 36. Immobile oil layer 38 corresponds to oil sand 10 and the native bitumen contained therein. The temperature of immobile oil layer 38 is the lowest among interface layers 30 through 38, but still exhibits a thermal gradient due to heat flux from the injected steam.

One can consider these five interface layers 30 through 38 at incrementally small regions of the overall steam-bitumen interface. Within these regions, the gradients of temperature, species concentration, and the like are steepest in the direction normal to the steam-bitumen interface to such an extent that one-dimensional gradients of the relevant physical properties and processes are applicable. For example, as shown in FIG. 2c, heat flux, temperature, oil fraction, and water fraction can all be represented by one-dimensional gradients of those processes at this location of the steam-bitumen interface, in the direction normal to interface layers 30 through 38.

In some embodiments of this invention, the interface between injected steam from wellbore 4a and native bitumen within the modeled volume containing steam chamber 12 is represented by Lagrangian points that move through the fixed Eulerian mesh of the formation. As such, the application of the MPM approach to evaluation of the SAGD technique, according to embodiments of this invention, will be referred to in this description as the “interface particle method”, or “IPM”, as the particles will be tracking the movement of an interface rather than the movement of specific elements of material. An example of such a Lagrangian point is shown in FIG. 2c by interface marker particle IMP at the interface between water-continuous dispersion layer 32 and oil-continuous dispersion layer 34, from which the movement of the other layers and mechanisms can be inferred. Other particles IMP can be assigned at points along this interface between layers 32, 34, cumulatively representing the boundary of steam chamber 12. Alternatively, particles IMP may be sited at other locations within the interface region, if desired. Movement of the cumulative set of these marker particles IMP over the simulation time period can thus illustrate the size, shape, and growth of steam chamber 12 in response to the injected steam over that time. According to embodiments of this invention, each Lagrangian interface marker particle IMP will thus convey the position and movement of the oil-bitumen interface, and will also carry useful information about the interface at its location. This information may directly express, or can be used to infer, properties of thickness, temperature, and species concentrations on either side of that particle, as these properties are affected on a spatial scale that is much smaller than the scale of the Eulerian grid. For example, it is contemplated that the thickness of the “water layer” within which the injected steam is forming an emulsion with the retained oil (i.e., the thickness of the five-layer interface of FIG. 2c) may be on the order of 5 cm, while the grid cell size conventionally used in the modeling and simulation of the formation is on the order of 4 meters on a side. These interface marker particles IMP are thus able to capture the fine structure detail of the steam-bitumen interface over simulation time.

Under the IPM model implemented according to embodiments of this invention, the relevant physical gradients are characterized as one-dimensional processes in the direction normal to the interface, by way of which the critical transfer processes can be resolved. The solutions of these one-dimensional processes within the simulation are then communicated from interface marker particles IMP to grid nodes on both sides of the interface, and those mesh node values are then applied to computations at the macroscopic scale (i.e., the scale of the SAGD steam chamber) to model macro effects such as oil flow. From the macro-scale solutions, motion of the marker particles assigned to the steam-bitumen interface along and within the grid can be inferred, so that the location of the steam-bitumen interface can be tracked as oil is produced from oil sand 10 by the injected steam over time.

In the SAGD context and according to embodiments of this invention, this information carried by the interface marker particles include heat transport models and physical transport or momentum models for each of the phases of interest (e.g., oil, steam, and the water-oil emulsion). Models of chemical reactions and chemical transport mechanisms occurring at the steam-bitumen interface may also be carried by the interface marker particles; in some embodiments, it is contemplated that these chemical models can express the effects of surfactants and solvents at the steam-bitumen interface. These models may be carried on the interface marker particles in the form of a system of partial differential equations reflecting the relevant physical mechanisms as one-dimensional gradients in the direction normal to the interface. It is contemplated that these models can be used to infer values for parameters such as layer thickness, temperatures, and species concentrations on both sides of the interface (e.g., the five layers of FIG. 2c).

FIG. 2d illustrates a plot of one such equation represented by the plot of concentration Cₖ at interface marker particle IMPₖ. In this example, interface marker particles IMPₖ₋₁, IMPₖ, IMPₖ₊₁ are at the interface between steam layer 30 and water layer 32′ (which is inclusive of layers 32, 34, 36 of FIG. 2c), serving as the location of the interface being tracked by particles IMP in this example. The position of mesh nodes MN are illustrated in FIG. 2d; in this example, mesh nodes MNᵢⱼ, MN_{i,j+1}, MN_{i+1,j}, MN_{i+1,j+1} surround particles IMPₖ, IMPₖ₋₁. Concentration Cₖ is representative of some parameter that exhibits a discontinuity (i.e., is infinite-valued) at the location of particle IMPₖ in this example. As such, the gradient of concentration Cₖ exhibits a one-dimensional gradient in the direction n normal to the tangent τ of the interface that has significant variation within the grid cell defined by mesh nodes MNᵢⱼ, MN_{i,j+1}, MN_{i+1,j}, MN_{i+1,j+1}, but which would not be exhibited considering only behavior at the mesh nodes. It is this sort of sub-grid-scale gradient that embodiments of this invention address in the modeling and simulation of the mechanisms of the SAGD production technique.

According to the embodiments of the invention, a system of the partial differential equations carried by the interface marker particles is solved at a given point in simulation time, using boundary conditions established by the values currently at the surrounding mesh nodes. The solution of this system of equations is then communicated from the marker particles to the mesh nodes, updating the values at those nodes. These new values may affect the grid dynamic, or bulk fluid flow, which can be evaluated by solving the macro-level grid equations so as to account for the fluid flow over the time interval. The macro-level solution at this point can modulate the boundary condition values at the mesh nodes, which are applied in the solution of the system of partial differential equations at the next time interval. In addition, a selected parameter that determines the velocity of the movement of the interface points, or a corresponding criterion for defining the location of the interface points, is interpolated from the current conditions at the mesh nodes according to the appropriate shape function (e.g., bi-linear interpolation), and that velocity or location used to determine the position of each interface marker particle for the next time interval. The process then repeats at the next point in simulation time to solve the system of partial differential equations carried by the interface marker particles, communicate the solution to the mesh nodes, solve the macro-level grid equations, and move the interface marker particles accordingly. This iterative process continues over the desired simulation time, providing a numerical technique that enables the accurate and cost-efficient simulation and analysis of the complex mechanisms involved in oil production using the SAGD technique.

More specifically, the IPM simulation of the SAGD mechanism at the steam-bitumen interface is based on the solution of state equations for each of the particles, and of fluid flow at each mesh node, at time steps within the simulation time period. As described in the Zhang et al. J. Computational Physics paper incorporated above, this solution is performed in a subspace of continuous functions in which all functions take the form:

qₖ(x,t)=Σⱼ₌₁^{N}qₖⱼ(t)Sⱼ(x) (1)

where N is the number of mesh nodes in the domain, qₖⱼ is the value of quantity q of phase k at mesh node j, x and t are location and time variables, respectively, and Sⱼ is the shape function associated with the mesh nodes. As described in the “CartaBlanca Theory Manual” incorporated above, different shape functions may be used, depending on the type of elements; for example, bi-linear shape functions are suitable for quadrilateral and hexahedral elements.

In this example, and according to embodiments of this invention, the state equations correspond to expressions for the momentum of each phase in the system (e.g., oil, water, the water-oil emulsion, and perhaps sand or another solid phase corresponding to the formation matrix), enthalpy of the respective phases to allow modeling of heat transport and therefore the emulsification of the entrapped oil in the formation with the injected steam, and perhaps chemical reactions involving chemical reagents such as surfactants and solvents that may affect that emulsification mechanism. For example, a momentum equation for oil can be expressed as:

$${θ}_{o} {ρ}_{o}^{0} \frac{d {u}_{o}}{d t} = - {θ}_{o} ∇ P + ∇ \cdot ( {θ}_{o} {σ}_{v} ) - {θ}_{o} {θ}_{s} {f}_{so} - {θ}_{o} {θ}_{g} {f}_{go} \qquad ( 2 )$$

where θₒ is the volume fraction of oil, θₛ is the volume fraction of sand, θₛ is the volume fraction of gas, ρₒ⁰ is a nominal density of the oil, P is the pressure at the mesh node, σᵥ is a viscous stress tensor, fₛₒ represents an interaction between sand and oil in the nature of drag, f_{go} represents a drag interaction between gas and oil, and uₒ is the velocity vector of oil at that mesh node. As such, the left side of the equation represents momentum of oil at the mesh node, with the right side of the equation corresponding to a sum of a pressure gradient term, a viscous stress term, and terms representing drag between the oil and each of sand and gas. From this state equation at the mesh node, a corresponding partial differential equation for a marker particle can similarly be expressed as:

$${θ}_{s} {ρ}_{s}^{0} \frac{d {u}_{s}}{d t} = - {θ}_{s} ∇ P + ∇ \cdot [ {θ}_{s} ( {σ}_{s} + PI ) ] + ∇ \cdot ( {θ}_{s} {σ}_{v} ) - {θ}_{o} {θ}_{s} {f}_{so} - {θ}_{o} {θ}_{g} {f}_{go} \qquad ( 3 )$$

where ρₛ⁰ is a nominal density of the sand, P is the pressure at the location of the particle, (σₛ+PI) represents a linear elastic stress term, and uₛ is the velocity vector of that particle of sand. Typically, the gradients incorporated in this differential equation are simplified to one-dimension, considering the geometry of the interface as described above relative to FIG. 2c. As such, the left side of the equation represents momentum of the sand particle, with the right side of the equation corresponding to a sum of a pressure gradient term, an elastic stress term, a viscous stress term, and a term representing drag between the oil and sand. Similar state equations for momentum of other phases in the system, for enthalpies of oil and other phases, and for chemical reactions and effects, are similarly defined, with corresponding partial differential equations to be applied at the interface marker particles.

The state equations to be incorporated may be selected according to the nature of the sub-surface. For example, it is contemplated that the formation of interest to which embodiments of the invention will be useful will often be a porous medium in which the sand will not fail. In this type of formation, the general form of momentum equations (2), (3) specified above can be replaced by more specialized equations based on Darcy's law, as follows:

$$\begin{matrix}{θ}_{o} {u}_{o} = - {K}_{o} \frac{{k}_{o}}{{μ}_{o}} ∇ p & ( 4 a ) \\ {θ}_{s} {u}_{s} = - {K}_{o} \frac{{k}_{s}}{{μ}_{s}} ∇ p & ( 4 b ) \\ {θ}_{g} {u}_{g} = - {K}_{o} \frac{{k}_{g}}{{μ}_{g}} ∇ p & ( 4 c )\end{matrix}$$

for oil, sand, and gas, respectively. These more specialized equations for the porous sand formation will reduce computational cost, with little or no loss of accuracy. Other types of formations may similarly give rise to other corresponding specialized forms of the general state equations.

In addition to these momentum, enthalpy, and chemical reaction equations, the state equations in the system of equations include mass and energy conservation laws. For example, a mass balance equation expressing the conservation of mass among the oil, water, and emulsion phases, based on the volume fraction of each phase, is applicable:

$$\begin{matrix}\frac{\partial {θ}_{o}}{\partial t} + ∇ \cdot ( {θ}_{o} {u}_{o} ) = - \frac{{θ}_{o}}{{c}_{o}^{2} {ρ}_{o}} ( \frac{\partial P}{\partial t} + {u}_{o} \cdot ∇ P ) & ( 5 a ) \\ \frac{\partial {θ}_{s}}{\partial t} + ∇ \cdot ( {θ}_{s} {u}_{s} ) = 0 & ( 5 b )\end{matrix}$$

In addition, this system of equations includes the continuity constraint that the volume fractions of all materials sum to unity at each grid cell. Other constraints that may be applied according to embodiments of this invention include a heat balance constraint.

According to embodiments of this invention, the system of state equations and constraints applied to the mesh nodes, and to the interface marker particles by way of partial differential equations, are contemplated to enable calculation and evaluation of the following mechanisms at each time step within the desired simulation time, and at each mesh node near the position of the steam-bitumen interface at that time step:
heat exchange, namely conduction and convection
the amount of condensation or evaporation, based on enthalpy and gas-liquid equilibrium expressions
optionally, chemical reaction rates and products, for example to evaluate the effect of surfactants and solvents
   This system of equations is intended to express these and other parameters for each of the phases to be modeled, including oil, water-oil emulsion, steam, water, and sand or other material of the formation matrix. One or more of these phases may be present in multiple species, each of which can be expressed if desired.

According to embodiments of this invention, parameters in equations (2) and (3) in this example (or the more specialized state equations, such as equations (4a) through (4c), as discussed above) are set at initial conditions corresponding to the initial time point in the simulation interval, based on such extrinsic information representative of the sub-surface, including pressures, oil sand properties, and oil properties, as based on seismic surveys, well logs, measurements acquired from wells at or near the volume under analysis, existing models of the sub-surface, and the like. Given these initial conditions, the system of the partial differential equations and conservation laws, with constraints such as the continuity constraint, is then solved at each interface marker particle at each time point over the simulation time interval. These results at the particles are then communicated to the mesh nodes by application of the corresponding shape functions.

As a result, at each time point, properties such as phase momentum, phase concentrations, enthalpy, and the like are resolved at each mesh node in the modeled volume. These evaluated properties can then be applied to the macro-scale equations for evaluation of the parameters of interest, including densities of each phase of interest, and pressure at the mesh nodes. Another macro-scale solution of interest in the SAGD simulation is the evaluation of velocity using Darcy's Law, by way of which formation parameters such as permeability and porosity are included in the calculations. By solving Darcy's Law for the newly-updated values of pressure, density, etc., velocities of the phases of interest can be readily determined, from which oil flow toward the producing well can be calculated. This solution of Darcy's Law also leads to a velocity value that can be applied to the interface marker particles IMP in the vicinity of the mesh nodes, for example by interpolation according to a shape function.

According to an embodiment of this invention, random fluctuations in the porosity and permeability may be introduced into locations of oil sand 10 through which the marker particles at the steam-bitumen interface travel. These randomized values of porosity and permeability can be applied to the state equations, or to the grid scale equations. These random porosity and permeability fluctuations are contemplated to improve the ability of the MPM model to reflect the formation of steam “fingers” extending from steam chamber 12 at particular locations of the interface. For example, a sharply increased velocity of the interface marker particles IMP in the vicinity of the mesh nodes having a significantly higher porosity or lower permeability resulting from this randomization will be manifest by rapid movement of the interface at that location.

The evaluated velocity of each interface marker particle IMP at this time step is then multiplied by the time interval in the simulation time, resulting in a new position of each interface marker particle IMP. The system of equations is then again solved at these new particle locations, applying boundary conditions corresponding to the current values of the associated parameters now at the mesh nodes, comprehending the solution from the prior time interval and the effect of the evaluation of the grid-scale equations. The process then repeats.

It is contemplated that the density of the interface marker particles IMP along the boundary of steam chamber 12 will decrease with simulation time, as steam chamber 12 enlarges. In some embodiments of the invention, therefore, new interface marker particles IMP may be instantiated to ensure the desired resolution of the simulation.

As mentioned above, embodiments of this invention can be applied to the simulation of other processes and behaviors of interest in and related to the production of oil, particularly in the simulation of the behavior of sub-surface strata at or near one or more wellbores. In those other processes and behaviors, the state equations will of course differ from those described above in connection with the SAGD production environment. For example, one or more equations expressing the effects of primary and secondary water-flood operations, including the development of channels and wormholes, may be included in the state or conservation equations. Other state equations pertaining to these and other mass and energy relationships will be applicable in other simulated processes.

Particular embodiments of systems and methods operating according to this theory of operation, as applied to oil and gas reservoirs and production techniques, will now be described in detail.

Computerized System

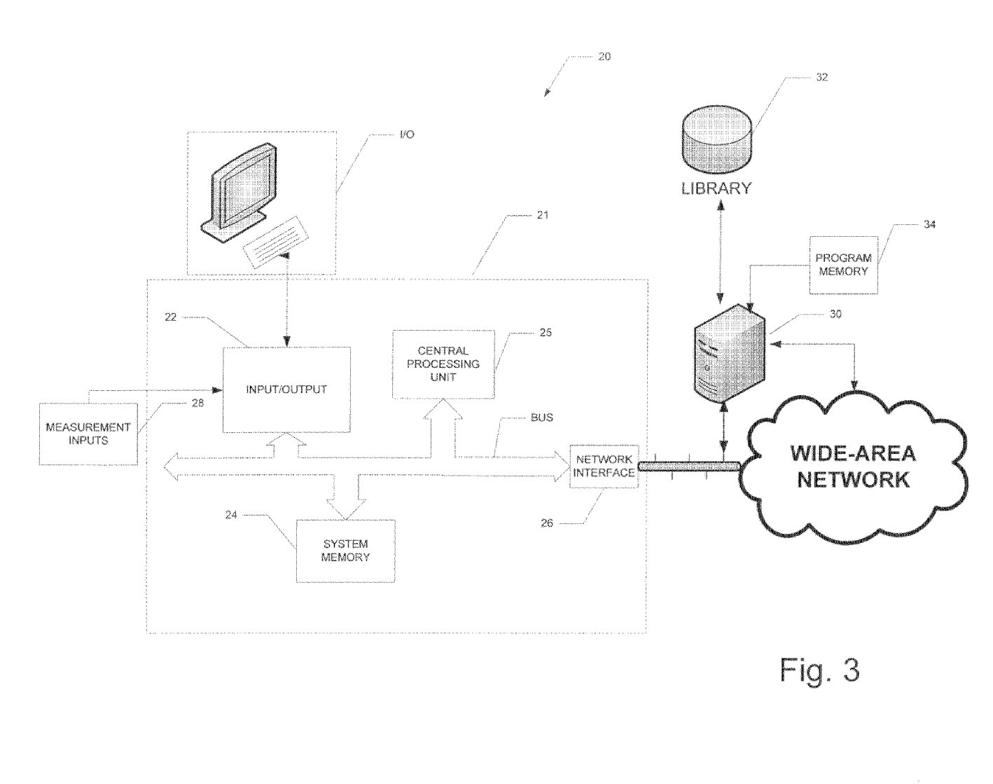

Embodiments of this invention are directed to a computerized method and system for simulating the behavior of a sub-surface region of the earth during oil and gas production operations, and more specifically for carrying out a simulation of the fluid and structural behavior of the modeled region. FIG. 3 illustrates, according to an exemplary embodiment, the construction of simulation system (“system”) 20, which performs the operations described in this specification to efficiently execute a simulation of the interaction of fluid and formation materials by way of a material point model (MPM) approach. In this example, system 20 can be realized by way of a computer system including workstation 21 connected to server 30 by way of a network. Of course, the particular architecture and construction of a computer system useful in connection with this invention can vary widely. For example, system 20 may be realized by a single physical computer, such as a conventional workstation or personal computer, or alternatively by a computer system implemented in a distributed manner over multiple physical computers. Accordingly, the generalized architecture illustrated in FIG. 3 is provided merely by way of example.

As shown in FIG. 3 and as mentioned above, system 20 includes workstation 21 and server 30. Workstation 21 includes central processing unit 25, coupled to system bus BUS. Also coupled to system bus BUS is input/output interface 22, which refers to those interface resources by way of which peripheral functions I/O (e.g., keyboard, mouse, display, etc.) interface with the other constituents of workstation 21. Central processing unit 25 refers to the data processing capability of workstation 21, and as such may be implemented by one or more CPU cores, co-processing circuitry, and the like. The particular construction and capability of central processing unit 25 is selected according to the application needs of workstation 21, such needs including, at a minimum, the carrying out of the functions described in this specification, and also including such other functions as may be executed by system 20. In the architecture of system 20 according to this example, system memory 24 is coupled to system bus BUS, and provides memory resources of the desired type useful as data memory for storing input data and the results of processing executed by central processing unit 25, as well as program memory for storing the computer instructions to be executed by central processing unit 25 in carrying out those functions. Of course, this memory arrangement is only an example, it being understood that system memory 24 can implement such data memory and program memory in separate physical memory resources, or distributed in whole or in part outside of workstation 21. In addition, as shown in FIG. 3, workstation 21 can also receive, via input/output function 22, measurement inputs 28 from sensors and transducers deployed at wells in the production field. These measurement inputs can be stored in a memory resource accessible to workstation 21, either locally or via network interface 26.

Network interface 26 of workstation 21 is a conventional interface or adapter by way of which workstation 21 accesses network resources on a network. As shown in FIG. 3, the network resources to which workstation 21 has access via network interface 26 includes server 30, which resides on a local area network, or a wide-area network such as an intranet, a virtual private network, or over the Internet, and which is accessible to workstation 21 by way of one of those network arrangements and by corresponding wired or wireless (or both) communication facilities. In this embodiment, server 30 is a computer system, of a conventional architecture similar, in a general sense, to that of workstation 21, and as such includes one or more central processing units, system buses, and memory resources, network interface functions, and the like. According to this embodiment of the invention, server 30 is coupled to program memory 34, which is a computer-readable medium that stores executable computer program instructions, according to which the operations described in this specification are carried out by analysis system 20. In this embodiment of the invention, these computer program instructions are executed by server 30, for example in the form of an interactive application, upon input data communicated from workstation 21, to create output data and results that are communicated to workstation 21 for display or output by peripherals I/O in a form useful to the human user of workstation 21. In addition, library 32 is also available to server 30 (and perhaps workstation 21 over the local area or wide area network), and stores such archival or reference information as may be useful in system 20. Library 32 may reside on another local area network, or alternatively be accessible via the Internet or some other wide area network. It is contemplated that library 32 may also be accessible to other associated computers in the overall network.

Of course, the particular memory resource or location at which the measurements, library 32, and program memory 34 physically reside can be implemented in various locations accessible to system 20. For example, these data and program instructions may be stored in local memory resources within workstation 21, within server 30, or in network-accessible memory resources to these functions. In addition, each of these data and program memory resources can itself be distributed among multiple locations, as known in the art. It is contemplated that those skilled in the art will be readily able to implement the storage and retrieval of the applicable measurements, models, and other information useful in connection with this embodiment of the invention, in a suitable manner for each particular application.

According to this embodiment of the invention, by way of example, system memory 24 and program memory 34 store computer instructions executable by central processing unit 25 and server 30, respectively, to carry out the functions described in this specification, by way of which a computer simulation of the behavior within a modeled volume of the desired sub-surface portion of the earth can be executed. These computer instructions may be in the form of one or more executable programs, or in the form of source code or higher-level code from which one or more executable programs are derived, assembled, interpreted or compiled. Any one of a number of computer languages or protocols may be used, depending on the manner in which the desired operations are to be carried out. For example, these computer instructions for creating the model according to embodiments of this invention may be written in a conventional high level language such as JAVA, FORTRAN, or C++, either as a conventional linear computer program or arranged for execution in an object-oriented manner. These instructions may also be embedded within a higher-level application. More specifically, it is contemplated that the simulation of the behavior of the modeled sub-surface volume may be carried out by way of a computer simulation software application or package operating according to the material point model (MPM) technique, such as the CARTABLANCA computer simulation environment licensable from the Los Alamos National Laboratory. In any case, it is contemplated that those skilled in the art having reference to this description will be readily able to realize, without undue experimentation, this embodiment of the invention in a suitable manner for the desired installations. These executable computer programs for carrying out embodiments of this invention may be installed as resident within system 20 as described above, or alternatively may be in the form of an executable web-based application that is accessible to server 30 and client computer systems such as workstation 21 for receiving inputs from the client system, executing algorithms modules at a web server, and providing output to the client system in some convenient display or printed form. Alternatively, these computer-executable software instructions may be resident elsewhere on the local area network or wide area network, or downloadable from higher-level servers or locations, by way of encoded information on an electromagnetic carrier signal via some network interface or input/output device. The computer-executable software instructions may have originally been stored on a removable or other non-volatile computer-readable storage medium (e.g., a DVD disk, flash memory, or the like), or downloadable as encoded information on an electromagnetic carrier signal, in the form of a software package from which the computer-executable software instructions were installed by system 20 in the conventional manner for software installation.

Operation of the Computerized System

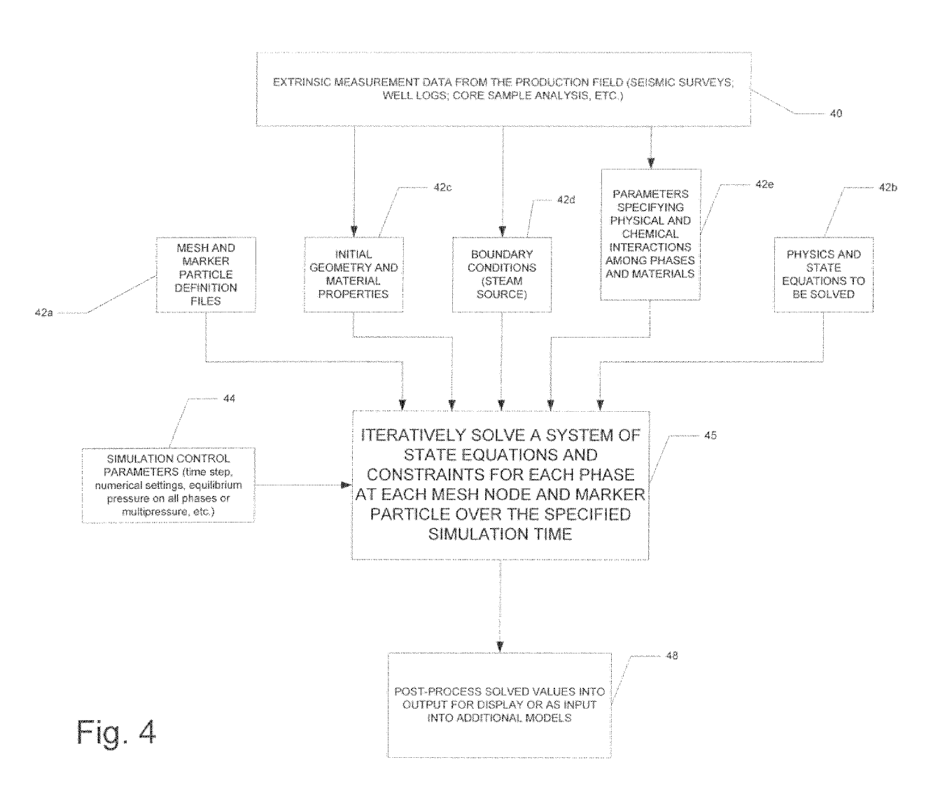

FIG. 4 illustrates the generalized operation of system 20 in executing a simulation of fluid flow and structural degradation in a modeled volume of the sub-surface at an oil sand reservoir, according to an embodiment of the invention. By way of example, this description will refer to data and simulation results pertaining to the mechanisms involved in SAGD oil production; it is to be understood, of course, that this invention may alternatively be applied to the simulation of other mechanisms involved in oil production. As discussed above, it is contemplated that the various steps and functions in this process can be performed by one or more of the computing resources in system 20 executing computer program instructions resident in the available program memory, in conjunction with user inputs as appropriate. While the following description will present an example of this operation as carried out at workstation 21 in the networked arrangement of system 20 shown in FIG. 3, it is of course to be understood that the particular computing component used to perform particular operations can vary widely, depending on the system implementation. As such, the following description is not intended to be limiting, particularly in its identification of those components involved in a particular operation. It is therefore contemplated that those skilled in the art will readily understand, from this specification, the manner in which these operations can be performed by computing resources in these various implementations and realizations. Accordingly, it is contemplated that reference to the performing of certain operations by system 20 will be sufficient to enable those skilled readers to readily implement embodiments of this invention, without undue experimentation.

As mentioned above, it is contemplated that system 20 will be programmed, according to embodiments of this invention, with computer programs that, when executed by computing resources in system 20, will carry out the various processes described in this specification for simulations of the sub-surface of the earth as specified by various physical parameter values and relationships. An example of suitable computer software in which embodiments of this invention have been observed to be successfully implemented, is the CARTABLANCA computer simulation environment available and licensable from Los Alamos National Laboratory. The CARTABLANCA computer software is described in Giguere et al., “CartaBlanca User's Manual”, Los Alamos National Laboratory Report No. LA-UR-07-8214 (2007); and Zhang et al., “CartaBlanca Theory Manual: Multiphase Flow Equations and Numerical Methods”, Los Alamos National Laboratory Report No. LAUR-07-3621 (2007), both available at http://www.lanl.gov/projects/CartaBlanca/, and both incorporated herein by this reference.

FIG. 4 illustrates a generalized flow diagram for the desired simulation of the behavior of fluid and solid phases in the sub-surface, in the context of an oil sand reservoir, according to embodiments of this invention in which a material point model (MPM) method expresses the modeled volume, including an interface that moves within that volume over time in response to the injection of steam. As described above, the MPM approach expresses the modeled volume by both a Eulerian mesh and Lagrangian integration points, with the Eulerian mesh remaining fixed through the simulation time while the Lagrangian points move through the mesh as the material deforms. More specifically, the flow of fluids within the modeled volume can be analyzed with respect to the Eulerian mesh (or grid), while the movement of an interface between constituent ones of that fluid can be analyzed as marker particles corresponding to the Lagrangian integration points. According to embodiments of this invention, the simulation must of course be designed to represent the modeled volume and the various attributes in that context. In the flow diagram of FIG. 4, this design of the grid or mesh for the modeled volume and the particles within that volume are specified by the user of system 20 by way of definition files 42a, which are stored in and retrieved from library 32 or another memory resource within system 20. In a general sense, definition files 42 define the Eulerian grid representative of the modeled volume, in the conventional manner for Eulerian-type models and simulation (e.g., finite element models), including the locations of mesh nodes, the sizes of grid cells (i.e., distances between adjacent mesh nodes), and the like. In the context of the CARTABLANCA simulation environment, this grid represented in definition files 42 may be defined as an unstructured or structured grid of triangular, quadrilateral, tetrahedral, hexahedral elements; it is contemplated, in this regard, that an unstructured grid can more readily enable the modeling and simulation of complex geometrical shapes and mathematical domains. The coordinate systems for the grid defined by files 42 may be Cartesian, cylindrical, or spherical, also under user selection. Definition files 42 also specify the initial coordinates of the Lagrangian points (i.e., interface marker particles) within the modeled volume. For purposes of this description, elements within the defined Eulerian grid for the modeled volume will be referred to by way of “mesh nodes”, it being understood that either grid cells (i.e., the volume between mesh nodes) or mesh nodes (i.e., the vertices of grid cells) may be the fundamental unit, depending on user and system preference. Also for purposes of this description, the Lagrangian integration points represented in the modeled volume will be referred to as “marker particles”, it being understood that these integration points will not correspond to physical particles at all, but will instead correspond to a mathematical representation of a physical interface.

In embodiments of this invention, as will be described in detail below, the simulation of the multiphase behavior in the modeled volume defined by definition files 42 will be carried out by numerical solution of a system of equations of state for the relevant materials and phases. Accordingly, the simulation requires specification of those equations of state, in order to define the desired simulation. According to embodiments of this invention, the equations of state and expressions of the physics involved in the simulation are provided as inputs 42b. These equations and expressions will be ultimately the subject of numerical solution, and as such the particular form of inputs 42b will correspond to the simulation and numerical engine of system 20 in executing this process.

For the example of the CARTABLANCA simulation environment, the physics inputs included within inputs 42b include user-specified indications of the physical processes to be modeled (e.g., a flow system including phase momentum, heat transport, chemical transport and reactions, for the example of SAGD oil production), relevant physical constants to those processes, and the particular simulation algorithms to be used for their solution. For example, inputs 42b may specify the user selection of a flow system for momentum transport of material in the simulation, the number of phases to be modeled by way of a Eulerian algorithm, the number of phases to be modeled by a particle-in-cell (i.e., IPM) algorithm, and the like. The particular equations of state to be solved are thus determined by the selection of the processes and simulation algorithms to be applied as made within inputs 42b, and are thus resident within the executable simulation software, as will be described below.

In the oil and gas context, as known in the art, various sources of extrinsic inputs 40 are available for use in constructing a realistic model of the sub-surface volume of interest in the desired simulation. As shown in FIG. 4, these extrinsic inputs 40 include measurement data relevant to the modeled volume constituting at least part of the production field of interest. Examples of those measurement data include the results of seismic surveys of that region of the earth, the results of conventional well logs and core sample analysis, and the like. In addition, other information corresponding to measurements or analysis of the earth in connection with previous exploration or production activity, as well as structural data deduced from other models and simulations pertaining to the relevant modeled volume, can also be included in extrinsic data 40 that are useful to this overall process.

According to some embodiments of the invention, these extrinsic inputs 40 include data corresponding to permeability and porosity of the modeled volume, with that permeability and porosity varying among locations in that volume. It is further contemplated that, in some of these embodiments, either or both of these permeability and porosity values are randomized to some extent. Such randomization is contemplated to give rise to simulation results that are more realistic than would be provided without such randomization. In particular, in the SAGD production context, it is contemplated that the randomization of either or both of porosity and permeability will enable the simulation to present “steam fingers” extending from the steam chamber formed by the SAGD process. These steam fingers have been observed to form in actual production fields, yet their formation is not accounted for in conventional simulation programs and packages. It is contemplated that the fidelity of the MPM simulation method described herein will provide greater fidelity in the simulation result, by allowing for the formation of these steam fingers as evident in actual practice.

For purposes of simulation according to embodiments of this invention, these extrinsic data 40 are expressed into the simulation executed by system 20 by way of various inputs 42c, 42d, 42e, as shown in FIG. 4. Inputs 42c correspond to specification of the geometry of the modeled volume and the structures within that volume, and properties of the materials of the phases within that volume at the relevant locations. For example, if the modeled volume corresponds to a portion of oil sand 10 near wellbores 4a, 4b, some locations of the modeled volume will represent oil sand 10 and perhaps others will represent the formations on one side or another of oil sand 10, for example overburden shale 15. One class of inputs 42c are the properties to be represented at the mesh nodes in the IPM algorithm, such inputs 42c reflecting properties such as permeability, porosity, and other structural attributes of the formation at the locations of those mesh nodes. Another class of inputs 42c are attributes to be represented by interface marker particles corresponding to the location and attributes (temperature, composition, etc.) of the steam-bitumen interface in the reservoir being produced using SAGD technology. For these particles, inputs 42c will include values for parameters such as how many computational particles are to be evaluated within the volume, and material property values such as viscosities, stress moduli, Poisson ratio, and the like. The particular material properties included within inputs 42c will, of course, depend on the desired simulation.

Inputs 42d represent macro-scale boundary conditions of the modeled volume. These boundary conditions will typically be based on extrinsic data 40, in particular the location and nature of interfaces between a producing formation of interest (e.g., an unconsolidated oil sand) and any adjacent confining formation such as an impermeable rock, overburden shale 15, or the like. More generally, these boundary conditions will express whether the boundary is reflective or transmissive (and the extent to which the boundary is so), whether a pressure is exerted on the modeled volume at that boundary (e.g., a drive source such as an aquifer in the oil and gas context), whether fluid is coming into the modeled volume or exiting the volume model at that boundary, and the like. These boundary conditions can be communicated to the mesh nodes in the IPM modeling of the formation, for example including pressure at the locations of those mesh nodes.

For embodiments of the invention, important mechanisms in the desired simulation are gradients in temperature and species concentration. For the case of the simulation of oil production in SAGD, these mechanisms and processes include flow effects, heat transport and thermal energy exchange, and chemical transport. As such, inputs 42e pertain to the physical and chemical interaction (as the case may be) among the various phases, and are provided to the simulation algorithm. For the case of steam-bitumen interaction, these inputs 42e include coefficients required by the state equations to be considered in the simulation solution. Other phases may also be included within the modeled volume, some of which may have no interaction with one or more of the other phases in that volume. As before, it is contemplated that these inputs 42e are provided based on extrinsic measurement data 40, thus having real-world correspondence to the properties of those materials in the simulation being undertaken.

The user of system 20 also provides inputs 44 to the simulation that serve as control parameters to the simulation. These control parameter inputs 44 include values such as the length of time steps between solution points over the simulation period, the number of time steps (i.e., the product of which with the length of time step defines the simulation time period), whether pressure in the modeled volume is assumed to be constant over all phases (i.e., an equilibrium pressure condition) or if instead each phase carries its own pressure value, numerical settings such as an advection “Courant” number defining a tradeoff between solution stability and run time, the dimensions of the simulation (1-D, 2-D, or 3-D), and other numerical parameters that control the stability or operation of the simulation to be performed.

Upon definition of the various inputs 42 and parameters 44, simulation process 45 is then executed by system 20 to iteratively solve the various state equations in the system at each mesh node and particle. According to embodiments of this invention, for example as executed within the CARTABLANCA simulation environment, these state equations include partial differential equations that serve as the basis of the simulation. In a general sense, simulation process 45 is carried out by discretizing these partial differential equations, and numerical techniques such as Jacobian-free Newton-Krylov (JFNK) algorithms are applied to solve the system of equations at each time step, for each mesh node and particle. Those solved values at each time step, for example corresponding to the time-dependent volume fraction of each phase within each grid cell within the modeled volume and to the temperature at those locations, are then stored in a memory resource of system 20. Upon completion of the simulation over the desired time interval, post-processing of those values into a usable output is performed in process 48. Process 48 may consist of generation of a visual display of the materials at the graphics display of workstation 21, for example as a sequence of snapshots of the volumes of each phase at each time step (or selected time steps) over the simulation period to allow the user to visualize the simulated behavior of the fluid and solid in the modeled volume, or a database of the solved values suitable for construction of an additional model or as inputs into a larger-scale simulation, or the like.

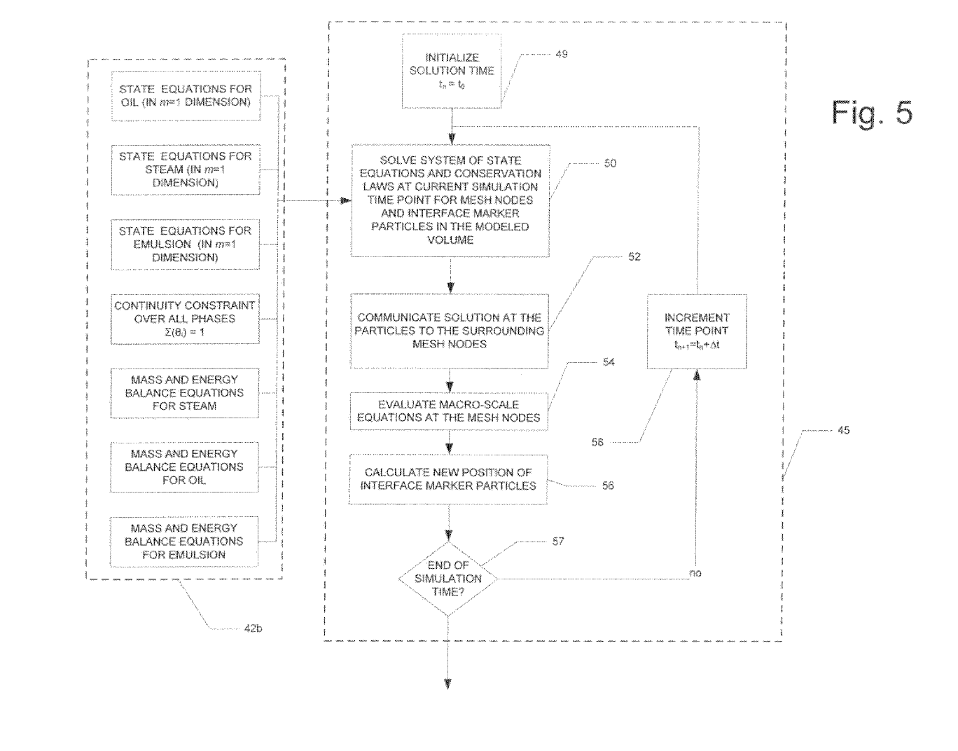

FIG. 5 illustrates a generalized example of the operation of system 20 in executing simulation process 45 as applied to the context of SAGD oil production. In this example, discretized versions of state equations 42b for the modeled volume are solved in process 45 at each time step for each mesh node and interface marker particle. As discussed above, in this example, these state equations 42b include momentum, heat transport and the corresponding emulsification of the entrapped oil in the formation with the injected steam, and perhaps chemical transport equations for each phase (oil, steam, and emulsion), in each dimension (e.g., in one dimension, for the case of the model described above relative to FIG. 2c), mass and energy balance (i.e., conservation) equations for each phase, and a continuity constraint corresponding to the modeled volume (i.e., the sum of all phase volume fractions equals 1). The particular state equations and constraints applied for a given situation are described above in connection with the theory of operation.

In the simplified and generalized flow diagram of FIG. 5, process 45 begins with the initialization of the solution time tₙ to the desired time t₀ in process 49; this time t₀ of course corresponds to the point in time at which initial conditions specified by inputs 42c, 42d are valid, and from which the simulation is to begin. The initial locations of the interface marker particles IMP may also be selected at this point; for example, the initial locations may be at or slightly away from the location of injection well 41. In process 50, the system of state equations 42b is solved at the current solution time tₙ at each interface marker particle IMP of interest, applying boundary conditions as specified by the initial values at the mesh nodes. It is contemplated that conventional numerical techniques and algorithms for solving systems of equations, including partial differential equations, as known by those skilled in the art having reference to this specification, will be suitable for carrying out process 50.

The solution obtained at the interface marker particles IMP in process 50 is then used to update parameter values at each of the mesh nodes MN near the current locations of the particles. Of course, the number of mesh nodes MN in the overall volume of interest will be much greater than the mesh nodes MN updated in each instance of process 52, as only those mesh nodes MN near the current position of the steam-bitumen interface will typically be affected by the solution of process 50, considering that the processes reflected by the state equations will generally act on a sub-grid-scale during the SAGD production process. This updating of the parameter values at the affected mesh nodes MN is executed by the communicating of the solution at the particles IMP to those mesh nodes MN in a manner consistent with the differential equations in the solved system, in process 50.

In process 54, various grid-scale or macro-scale equations at the mesh nodes are evaluated, based on the updated values communicated from the interface marker particles IMP in process 52. It is contemplated that these macro-scale equations will include such calculations as:
heat exchange, namely conduction and convection
the amount of condensation or evaporation, based on enthalpy and gas-liquid equilibrium expressions
optionally, chemical reaction rates and products, for example to evaluate the effect of surfactants and solvents
   From these calculations, it is contemplated that such parameters as density of each phase of interest and the localized pressure will also be evaluated in process 54, at each mesh node MN affected at this time step.

In process 56, the macro-scale parameters evaluated in process 54 are applied to one or more equations based on Darcy's Law to calculate the velocity of interface marker particles IMP. According to some embodiments of the invention, these equations incorporate local values of porosity and permeability of the formation at the locations of the mesh nodes MN of interest, from which a velocity or location of the corresponding phases can be obtained. This determination of process 56 may be based on evaluation of a parameter defining the interface point is selected. For example, the location of interface marker particle IMP may be selected as the position at which the volume fractions of oil and water are equal to one another, such a location being inferable from the macro-scale equation evaluation of process 54. Another approach may derive the velocity or location by applying a simple gas law relationship. According to other embodiments, the location of the interface marker particles IMP may be defined by the locations at which the velocity of a selected phase (e.g., steam) is at a selected value, or at which enthalpy or local temperature is at a selected value. Other alternative approaches include the application of Rankine-Hugoniot relations to derive the interface velocity from the conditions evaluated in processes 52, 54. In each case, it is contemplated that this determination of the location or velocity of the interface within the grid will be performed by interpolation of the updated parameter values at mesh nodes MN to the current location of interface marker particle IMP according to the applicable shape functions (e.g., bi-linear interpolation). For the example of the CARTABLANCA simulation environment, quantities are approximated as an average value over a median mesh control volume that surrounds each mesh node. Process 56 thus determines a new position of each interface marker particle IMP within the Eulerian grid.

Decision 57 is then executed by system 20 to determine whether the simulation time interval is complete. If not (decision 57 is “no”), the solution time is incremented to solution time tₙ₊₁ by the time step Δt indicated in control parameters 44, and process 50 is then repeated to again solve the state equations at that next simulation time, given the state of the phases, pressures, and the like expressed by the previous solution of those state equations.

More specifically, each iteration of state equation solution process 50 executes a numerical solution of a system of discretized equations, according to an appropriate numerical algorithm for such solution. In embodiments of this invention, as described above, solution process 50 can incorporate the MPM technique, particularly for addressing the movement of the steam-bitumen interface represented in the modeled volume according to the thermal and species concentration gradients over time, and the flow of the fluid phases as driven by gravity and the pressure field. In embodiments of this invention, the moving interface marker particles correspond to the movement of the steam-bitumen interface through the modeled volume resulting from the continuing injection of steam.

As discussed above solution process 50 may correspond to a numerical solution of the state equations that satisfies the continuity constraint at each time step, for each mesh node and particle. Under the CARTABLANCA simulation environment in this example, the momentum, transport, and mass conservation equations for the oil and sand phases may solved differently, for example with the mass and energy conservation equations for the oil phase solved at each mesh node by way of an Arbitrary Lagrangian-Eulerian (ALE) algorithm 52a, and with the momentum and mass conservation equations for the sand phase solved for each particle at that same solution time by an MPM algorithm 52b. As described in Zhang et al., “CartaBlanca Theory Manual: Multiphase Flow Equations and Numerical Methods”, supra, in this case resolution of the continuity constraint to account for interactions between these phases is numerically accomplished by generating “apparent” volume fractions at each mesh node (control volume surrounding each mesh node), because of the different solutions, and to arrive at the updated pressures in the modeled volume.

The above-incorporated U.S. Patent Application Publication No. US 2013/0096890 describes a “time-splitting” approach that can be used in simulations that involve a wide separation in time scales of the mechanisms being modeled. While it is contemplated that such time-splitting will not typically be necessary for simulation of the SAGD production, it is also contemplated that this time-splitting technique may be useful in specific applications of the SAGD oil production simulation method according to embodiments of this invention. For example, this time-splitting approach may be used in formations that have nearby shale strata that blocks fluid flow in the reservoir. In that and similar sub-surface situations, the time-splitting may be useful in the simulation of the puncturing of shale and other relatively impermeable structures in the vicinity of the SAGD well pair.

In the application of time-splitting to the SAGD process, an outer solution cycle may be used to derive the simulation of macro-scale fluid motion and production at relatively large time steps, with a subcycle at much smaller time steps performed periodically to evaluate the effect of the steam at specific locations, such as a confining shale stratum. For the simulation of SAGD production, the subcycle evaluates movement of the steam chamber over short time steps (e.g., on the order of microseconds) assuming the fluid state to be constant over each subcycle, while the outer cycle evaluates the fluid flow in a more macroscopic manner while assuming the position of the interface to be constant. It is contemplated that those skilled in the art having reference to this specification, including the above-incorporated U.S. Patent Application Publication No. US 2013/0096890, will be readily able to apply this time-splitting approach in the SAGD context. In this manner, movement of the steam chamber interface can be evaluated at a reasonable frequency, without burdening the evaluation of fluid flow over the longer time period. The simulation of the reservoir behavior in this situation can thus be efficiently evaluated by system 20 of modest computing capacity at reasonable computing times.

Referring back to FIG. 4, other reservoir simulation algorithms, such as conventional simulation of waterflood effects from an injector well in the modeled volume, particularly in simulating the extent to which waterflood fingers, channels, and wormholes can be formed, can be performed either after or in combination with process 48. Other modeling and simulation approaches can be used in combination with embodiments of this invention, both in “what-if” evaluation of possible future well and reservoir actions or in evaluating the effect of previously performed actions.

Embodiments of this invention as described above provide important benefits and advantages in the modeling and simulation of oil production by way of the SAGD technique. Each of the embodiments of this invention provide improved accuracy and resolution in the simulation of the behavior of the steam chamber formed in unconsolidated oil sand during the injection of steam according to the SAGD technology. These improved results can be attained by considering sub-grid-cell size gradients and effects, without involving prohibitive computational cost (such as would result by using smaller grid cells to improve resolution). Other pore scale interactions such as the effects of surface tension and of the detachment of oil droplets from the surface of sand particles, can also be studied by embodiments of this invention.

It is contemplated that those skilled in the art having reference to this specification will be readily able to recognize additional applications and scaling that utilize the modeling and simulation of multi-phase interaction provided by embodiments of this invention. It is therefore contemplated that this invention will be of significant value in the analysis of sub-surface mechanisms as useful in the oil and gas industry. And as discussed above, embodiments of this invention enable the use of modern computer systems to carry out such modeling and simulation, despite the wide separation in time and distance scales among the various mechanisms.

While this invention has been described according to its embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A method of operating a computer system to simulate the fluid and structural behavior of a volume of the earth near a wellbore, comprising the steps of:
retrieving, from a memory resource in the computer system, parameters defining properties of a sub-surface formation in the volume to be simulated at each of a plurality of mesh nodes in a grid representative of that volume;
selecting initial boundary conditions at each of the plurality of mesh nodes;
then, at each of a plurality of time steps over a simulation time period, operating the computer system to perform a plurality of operations comprising:
solving a system of equations comprising one or more state equations corresponding to transport mechanism models and balance constraints at each of a plurality of interface marker particles corresponding to the location of a steam-bitumen interface within the volume;
communicating values corresponding the solution of the system of equations to mesh nodes near each of the plurality of interface marker particles;
evaluating macro-scale equations corresponding to fluid flow at the plurality of mesh nodes;
updating the boundary conditions at the plurality of mesh nods responsive to the result of either or both of the solving and evaluating operations; and
changing the location of one or more of the interface marker particles responsive to the results of either or both of the solving and evaluating operations to estimate movement of the interface marker particles within the volume over the simulation time period.

2. The method of claim 1, wherein the state equations comprise one or more state equations for each of a plurality of phases, the plurality of phases comprising oil, steam, water, oil-water emulsion, and water-oil emulsion.

3. The method of claim 2, wherein the state equations for one or more of the plurality of phases comprise one or more of a momentum equation for the phase, an enthalpy equation for the phase, and an equation corresponding to a chemical reaction.

4. The method of claim 3, wherein the state equations corresponding to balance constraints comprise mass and energy balance equations.

5. The method of claim 1, wherein the solving operation comprises:
numerically solving a plurality of partial differential equations corresponding to the state equations, applying the boundary conditions at mesh nodes near to each of the plurality of marker interface particles.

6. The method of claim 1, further comprising:
randomizing parameters defining either or both of porosity and permeability properties of the sub-surface formation at one or more of the plurality of mesh nodes.

7. A computer system for simulating the fluid and structural behavior of a volume of the earth near a wellbore, comprising:
a processing unit for executing program instructions;
a memory resource, coupled to the processing unit, for storing data representative of properties at each of a plurality of mesh nodes in a grid representative of a sub-surface formation in the volume to be simulated, and data representative of properties for each of a plurality of marker particles corresponding to the location of a steam-bitumen interface within the volume; and
program memory, coupled to the processing unit, for storing a computer program including program instructions that, when executed by the one or more processing units, causes the computer system to perform a sequence of operations comprising:
retrieving, from the memory resource, parameters defining properties of a sub-surface formation in the volume to be simulated at each of a plurality of mesh nodes in a grid representative of that volume;
selecting initial boundary conditions at each of the plurality of mesh nodes;
then, at each of a plurality of time steps over a simulation time period, operating the computer system to perform a plurality of operations comprising:
solving a system of equations comprising one or more state equations corresponding to transport mechanism models and balance constraints at each of a plurality of interface marker particles corresponding to the location of a steam-bitumen interface within the volume;
communicating values corresponding the solution of the system of equations to mesh nodes near each of the plurality of interface marker particles;
evaluating macro-scale equations corresponding to fluid flow at the plurality of mesh nodes;
updating the boundary conditions at the plurality of mesh nods responsive to the result of either or both of the solving and evaluating operations; and
changing the location of one or more of the interface marker particles responsive to the results of either or both of the solving and evaluating operations to estimate movement of the interface marker particles within the volume over the simulation time period.

8. The system of claim 7, wherein the state equations comprise one or more state equations for each of a plurality of phases, the plurality of phases comprising oil, steam, water, oil-water emulsion, and water-oil emulsion.

9. The system of claim 8, wherein the state equations for one or more of the plurality of phases comprise one or more of a momentum equation for the phase, an enthalpy equation for the phase, and an equation corresponding to a chemical reaction.

10. The system of claim 9, wherein the state equations corresponding to balance constraints comprise mass and energy balance equations.

11. The system of claim 7, wherein the solving operation comprises:
numerically solving a plurality of partial differential equations corresponding to the state equations, applying the boundary conditions at mesh nodes near to each of the plurality of marker interface particles.

12. The system of claim 7, wherein the plurality of operations further comprises:
randomizing parameters defining either or both of porosity and permeability properties of the sub-surface formation at one or more of the plurality of mesh nodes.

13. A non-transitory computer-readable medium storing a computer program that, when executed on a computer system, causes the computer system to perform a sequence of operations for simulating the fluid and structural behavior of a volume of the earth near a wellbore, the sequence of operations comprising:
retrieving, from a memory resource in the computer system, parameters defining properties of a sub-surface formation in the volume to be simulated at each of a plurality of mesh nodes in a grid representative of that volume;
selecting initial boundary conditions at each of the plurality of mesh nodes;
then, at each of a plurality of time steps over a simulation time period, operating the computer system to perform a plurality of operations comprising:
solving a system of equations comprising one or more state equations corresponding to transport mechanism models and balance constraints at each of a plurality of interface marker particles corresponding to the location of a steam-bitumen interface within the volume;
communicating values corresponding the solution of the system of equations to mesh nodes near each of the plurality of interface marker particles;
evaluating macro-scale equations corresponding to fluid flow at the plurality of mesh nodes;
updating the boundary conditions at the plurality of mesh nods responsive to the result of either or both of the solving and evaluating operations; and
changing the location of one or more of the interface marker particles responsive to the results of either or both of the solving and evaluating operations to estimate movement of the interface marker particles within the volume over the simulation time period.

14. The medium of claim 13, wherein the state equations comprise one or more state equations for each of a plurality of phases, the plurality of phases comprising oil, steam, and water-oil emulsion.

15. The medium of claim 14, wherein the state equations for one or more of the plurality of phases comprise one or more of a momentum equation for the phase, an enthalpy equation for the phase, and an equation corresponding to a chemical reaction.

16. The medium of claim 15, wherein the state equations corresponding to balance constraints comprise mass and energy balance equations.

17. The medium of claim 13, wherein the solving operation comprises:
numerically solving a plurality of partial differential equations corresponding to the state equations, applying the boundary conditions at mesh nodes near to each of the plurality of marker interface particles.

18. The medium of claim 13, further comprising:
randomizing parameters defining either or both of porosity and permeability properties of the sub-surface formation at one or more of the plurality of mesh nodes.
